(19) United States
(12) Patent Application Publication
(10) Pub. No.: US 2002/0002581 A1
(43) Pub. Date: Jan. 3, 2002

(54) Messaging based proxy application management

(76) Inventor: Sameer Siddiqui, Milpitas, CA (US)

Correspondence Address: RITTER VAN PELT & YI, L.L.P., 4906 EL CAMINO REAL, SUITE 205, LOS ALTOS, CA, 94022

(21) Appl. No.: 09/864,935

(22) Filed: May 23, 2001

Related U.S. Application Data
(60) Provisional application No. 60/206,849, filed on May 23, 2000.

(51) Int. Cl. G06F 15/16

(52) U.S. Cl. 709/202; 709/206

(57) ABSTRACT

Sending network device instructions to a network device and receiving the instructions has been described. Sending the instructions includes receiving an application instruction generated by an application; uploading proxy agent instructions derived from the application instructions to a mail server; and confirming that the proxy agent instructions have been downloaded by a proxy agent. Receiving the instructions includes downloading a message from a mail server, the message including the network device instructions; authenticating the message; and parsing the instructions.

### CROSS REFERENCE TO RELATED APPLICATIONS

This application claims priority to U.S. Provisional Patent Application No. 60/206,849, filed May 23, 2000.

### FIELD OF THE INVENTION

The present invention relates generally to remote application management. More specifically, managing remote proxy agents via email messages is disclosed.

### BACKGROUND OF THE INVENTION

For many applications, it is desirable to have one or many remote agents monitor a process or collect data and report back to a central manager. In particular, for network management, it is desirable to have devices on a network report information to and receive instructions from a central manager. The Simple Network Management Protocol (SNMP) effectively provides a way for network monitoring and management devices to communicate with each other.

In many cases, using SNMP alone to manage network resources limits functionality. For example, it would be useful in many cases to be able to manage a network and obtain data about the network remotely from outside a firewall. Most firewalls reject SNMP commands from external sources. Ideally, it would be useful if a network could be managed and monitored remotely using a standard web browser. If this were possible, then network management could be provided by an Application Service Provider (ASP) over the web, creating many advantages. In addition, it would be beneficial if remote data acquisition and management could be efficiently and securely accomplished for other applications.

### SUMMARY OF THE INVENTION

Remote network management and monitoring using proxy agents and a proxy agent manager is disclosed. Remote proxy agents gather data and send commands to network management hardware. The remote proxy agents receive instructions from a central proxy agent manager via email. The proxy agent manager parses the instructions and forwards them to the appropriate proxy agents. As a result, an administrator communicating with the proxy agent manager can manage a network remotely from outside a firewall. In other embodiments, the proxy agent manager and proxies are used for remote data acquisition and management of other applications.

It should be appreciated that the present invention can be implemented in numerous ways, including as a process, an apparatus, a system, a device, a method, or a computer readable medium such as a computer readable storage medium or a computer network wherein program instructions are sent over optical or electronic communication links. Several inventive embodiments of the present invention are described below.

In one embodiment, a method of sending network device instructions to a network device includes receiving an application instruction generated by an application; uploading proxy agent instructions derived from the application instructions to a mail server; and confirming that the proxy agent instructions have been downloaded by a proxy agent.

In one embodiment, a method of receiving network device instructions for a network device includes downloading a message from a mail server, the message including the network device instructions; authenticating the message; and parsing the instructions.

In one embodiment, a proxy agent manager for sending network device instructions to a network device includes an application interface configured to receive an application instruction generated by an application; and a mail server interface configured to upload proxy agent instructions derived from the application instructions to a mail server and configured to confirm that the proxy agent instructions have been downloaded by a proxy agent.

In one embodiment, a network device for executing instructions from a remote manager includes a mail server interface configured to download a message from a mail server, the message including the instructions and a processor configured to authenticate the message and to parse the instructions.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram illustrating how a proxy agent manager and a number of proxy agents communicate with each other via e-mail.

FIG. 2 is a diagram illustrating the communication between a proxy agent and a mail server associated with the proxy agent manager.

FIG. 3 is a block diagram illustrating the architecture of a proxy agent manager.

FIG. 4 is a block diagram illustrating the architecture of a proxy agent.

FIG. 5 is an illustration of a format for an e-mail message sent by the proxy agent manager to a mail server.

FIG. 6 is a diagram illustrating the handshaking process that occurs when a command is sent from the proxy agent manager to a proxy agent.

FIG. 7 is a flow chart illustrating how a request is sent to the proxy agent manager and fulfilled by a proxy agent and a result is sent back to the proxy agent manager.

FIGS. 8A and 8B are flow charts illustrating the process executed on the proxy agent manager.

FIG. 9 is a flowchart illustrating the process implemented on a proxy agent.

FIG. 10 is a sample screen illustrating how a proxy agent may be configured using a browser interface.

FIG. 11 is a diagram illustrating a screen that may be used by a browser to monitor the status of a proxy agent.

### DETAILED DESCRIPTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

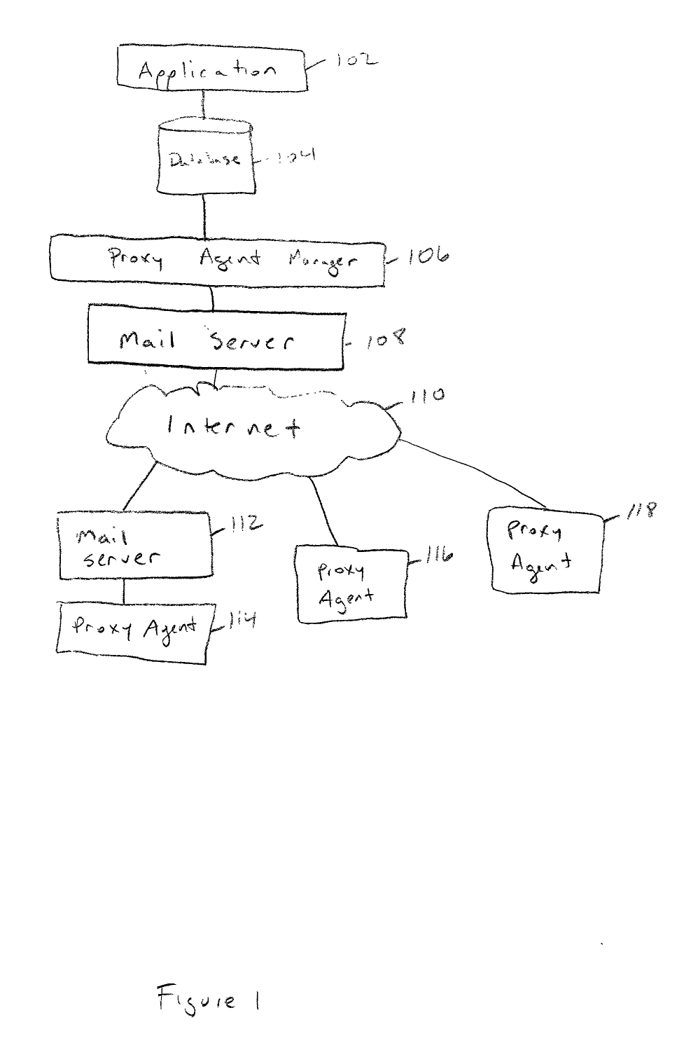

FIG. 1 is a block diagram illustrating how a proxy agent manager and a number of proxy agents communicate with each other via e-mail. An application 102 interfaces with a database 104 that is accessed by proxy agent manager 106. In one embodiment, the application, the database and the proxy agent manager all use the Java programming language. In some embodiments, the application may interface directly with the proxy agent manager instead of the proxy agent manager accessing the database that is also accessed by the application. Preferably, the application is accessible to administrators or users over the Internet. In one embodiment, the application is a network management program.

Proxy agent manager 106 determines that certain commands should be executed by remote proxy agents in order to fulfill the instructions sent to it by the application. To that end, proxy agent manager 106 creates instructions for each of the proxy agents, encrypts the instructions, adds a session ID and provides the encrypted instructions to mail server 108. In one embodiment, mail server 108 sends an e-mail to mail server 112 over the Internet 110. Proxy agent 114 is programmed to check mail server 112 periodically to determine whether any e-mails have been received from the proxy agent manager containing instructions for proxy agent 114.

Alternatively, instead of mail server 108 sending an e-mail to mail server 112 which has been configured to collect mail for proxy agent 114, mail server 108 may simply hold the message for a proxy agent such as proxy agent 116 or proxy agent 118. Proxy agent 116 and proxy agent 118 are configured to periodically retrieve mail over the Internet from mail server 108. This arrangement has the advantage that no remote mail server such as mail server 112 need be programmed to receive mail for a proxy agent. This simplifies setup since only the proxy agent need be configured to retrieve mail for itself over the Internet from a mail server.

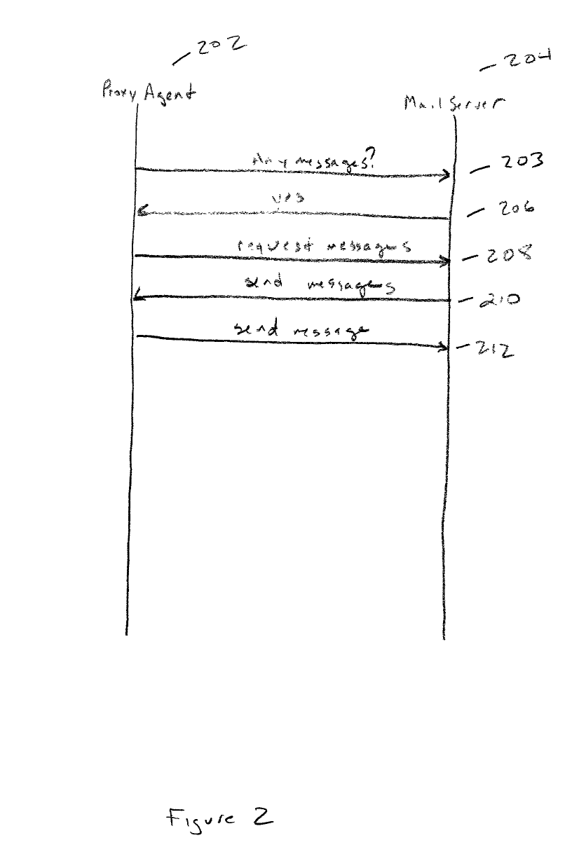

FIG. 2 is a diagram illustrating the communication between a proxy agent and a mail server associated with the proxy agent manager. Proxy agent 202 sends a message 203 to mail server 204 requesting any messages for proxy agent 202. Mail server 204 sends a reply 206 indicating that a message has been received for proxy agent 202. Proxy agent 202 then sends a message 208 requesting the messages and mail server 204 sends the messages 210. Once the proxy agent has executed the commands contained in the messages, it may send a message 212 with results back to the mail server. In one embodiment, the mail server is a pop3 mail server. Any appropriate mail server or mail protocol may be used for proxy agent 202 to retrieve its mail.

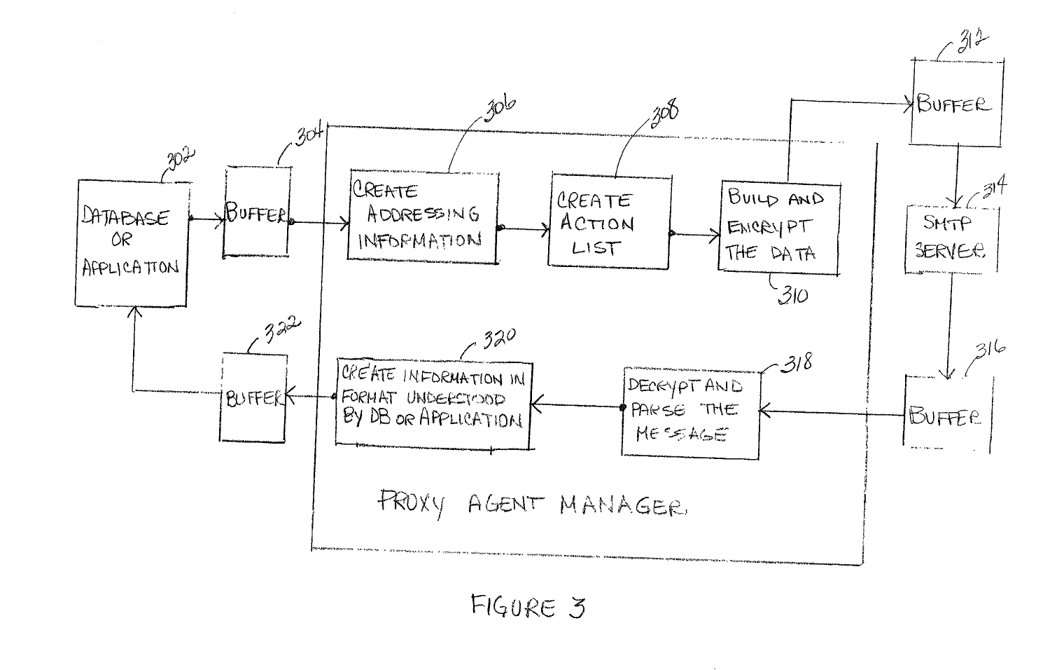

FIG. 3 is a block diagram illustrating the architecture of a proxy agent manager. A database or application 302 sends information through an interface represented by buffer 304 to a module in the proxy agent manager that creates addressing information. The addressing information is used to select the correct proxy agent to execute the task requested by the database or application. A module 308 creates an action list that lists the commands that are to be executed by the proxy agent. Module 310 builds and encrypts the data into an e-mail message that may be sent by SMTP server 314. The message is transferred to SMTP server 314 through an interface represented by buffer 312. When a message is received at SMTP server 314 from a proxy agent, the message is transferred to module 318 which decrypts and parses the message via an interface represented by buffer 316.

Once the message is decrypted and parsed, module 320 converts the message into information in a format that is understood by database or application 302. The information is transferred to database or application 302 through an interface represented by buffer 322. It should be noted that the modules may be all implemented on a single processor or the modules may run on separate processors if appropriate. In one embodiment, the modules run on a PC with a single microprocessor.

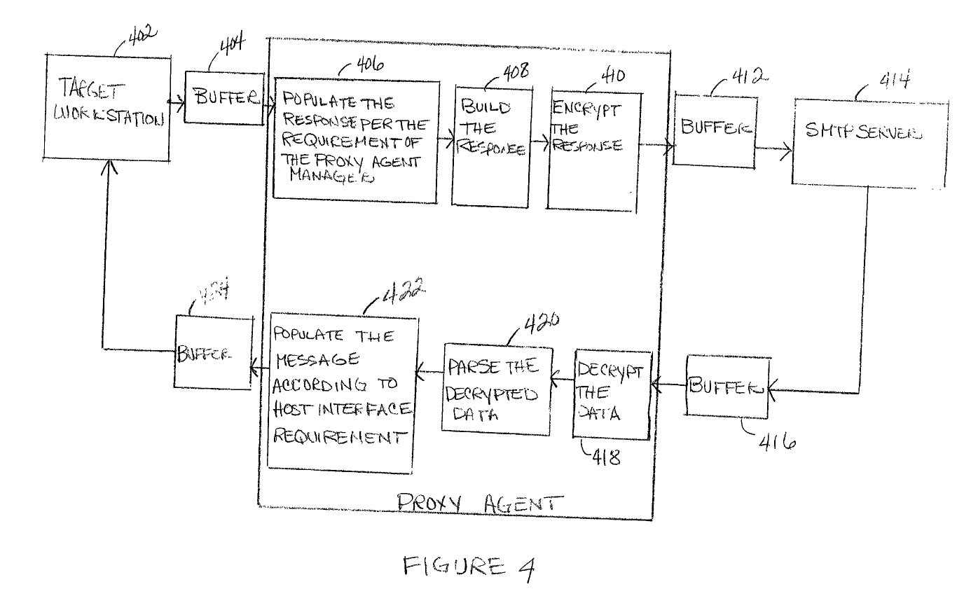

FIG. 4 is a block diagram illustrating the architecture of a proxy agent. Module 418 receives data through an interface represented by buffer 416 from a mail server 414. As noted above, mail server 414 may be located at the remote site where the proxy agent is located or, alternatively, mail server 414 may be located at the site where the proxy agent manager is found. Module 418 decrypts the data and the mail message. Module 420 parses the decrypted data into commands. Module 422 converts the parsed data from module 420 into a format that is understandable by the remote host that will execute the commands. The commands are sent to the remote host or target work station 402 via an interface which is represented by buffer 424.

Target work station 402 executes the commands, and, in some cases, obtains data. The data is transferred via an interface represented by a buffer 404 to module 406 which processes the response in a manner specified by the proxy agent configuration or by the proxy agent manager. The response is passed to module 408 which builds a response and module 410 which encrypts the response. The response is sent to mail server 414 via an interface 412 represented by buffer 412.

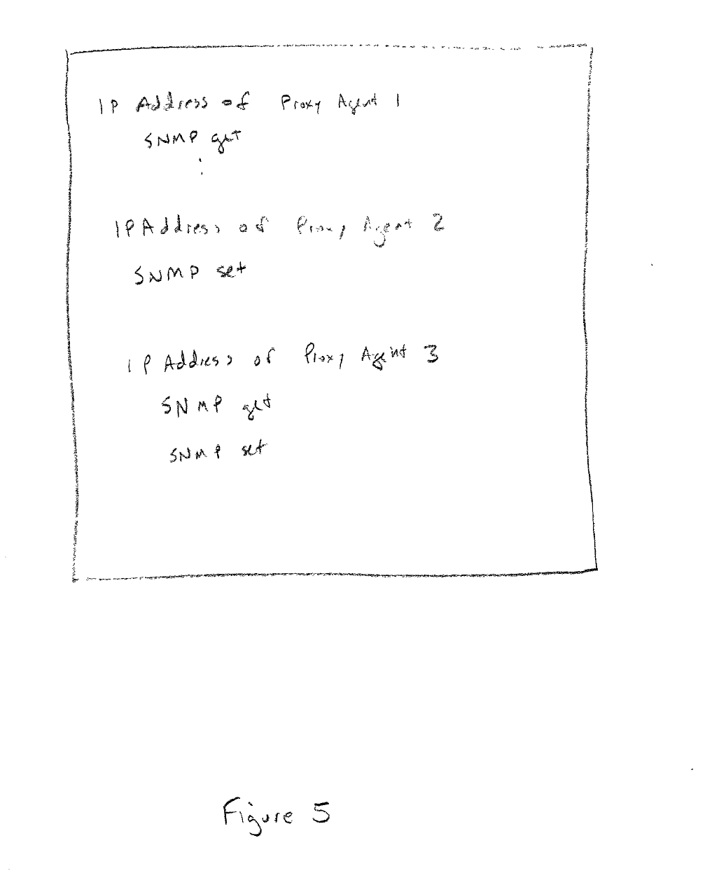

FIG. 5 is an illustration of a format for an e-mail message sent by the proxy agent manager to a mail server. The message includes instructions for several proxy agents. The instructions for proxy agent 1 begin with the IP address of the host for proxy agent 1 and then include a list of commands starting with an SNMP get. Likewise, the instructions for proxy agent 2 begin with the IP address for the host of proxy agent 2 and begin with an SNMP set command. The instructions for proxy agent 3 begin with the IP address of host proxy agent 3 and include an SNMP get and an SNMP set command.

Thus, the proxy agent manager receives information from a database or application and creates an encrypted e-mail that is sent to a mail server. The proxy agent retrieves the e-mail from the mail server, decrypts, authenticates and parses the message. In one embodiment, public key encryption is used to decrypt and authenticate the message. In other embodiments, other cryptographic techniques may be used. The proxy agent converts the message into instructions that are intended for its host.

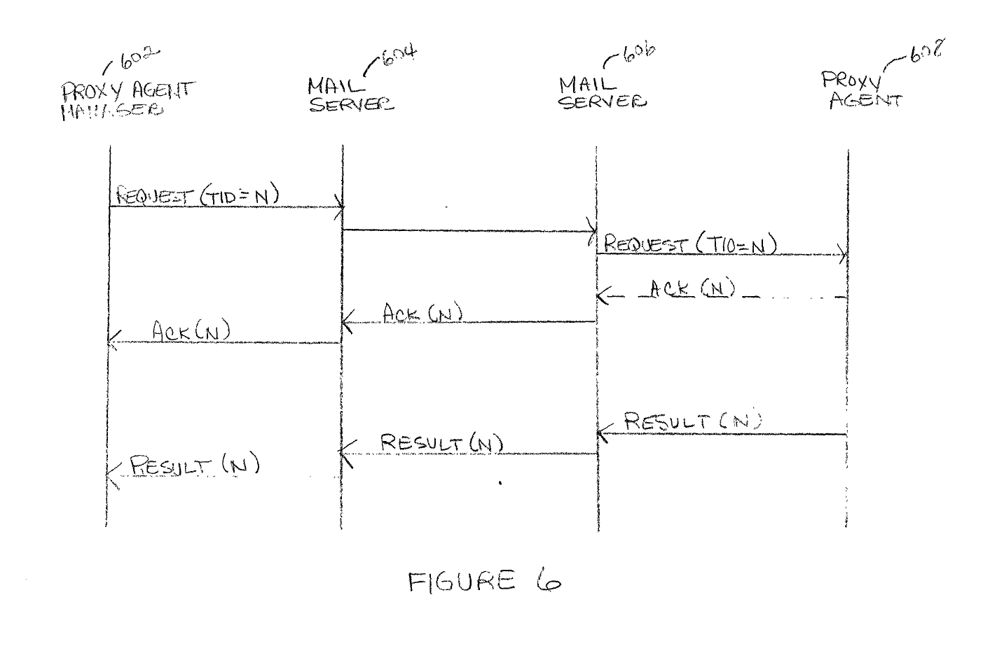

FIG. 6 is a diagram illustrating the handshaking process that occurs when a command is sent from the proxy agent manager to a proxy agent. Proxy agent manager 602 sends a request that is labeled by a transaction ID (TID). The request is sent to mail server 604. Mail server 604 forwards a request to mail server 606. Proxy agent 608 receives a request that is labeled by transaction ID N and replies with an acknowledgement that is labeled using the transaction ID N. The acknowledgement is forwarded from mail server 606 to mail server 604 and is downloaded by proxy agent manager 602.

In this manner, requests sent by the proxy agent manager are monitored and the proxy agent manager may resend requests as required. It should be noted that in some embodiments, mail server 604 and mail server 606 are combined into a single mail server so that the proxy agent logs onto the same mail server associated with the proxy agent manager as described above. When the proxy agent determines results based on the execution of the request labeled by transaction ID N, the result is sent along with the transaction ID to mail server 606. The result is forwarded to mail server 604 and is downloaded by proxy agent manager 602. Again, the transaction ID is used to match the result sent by the proxy agent to the earlier request sent by the proxy agent manager.

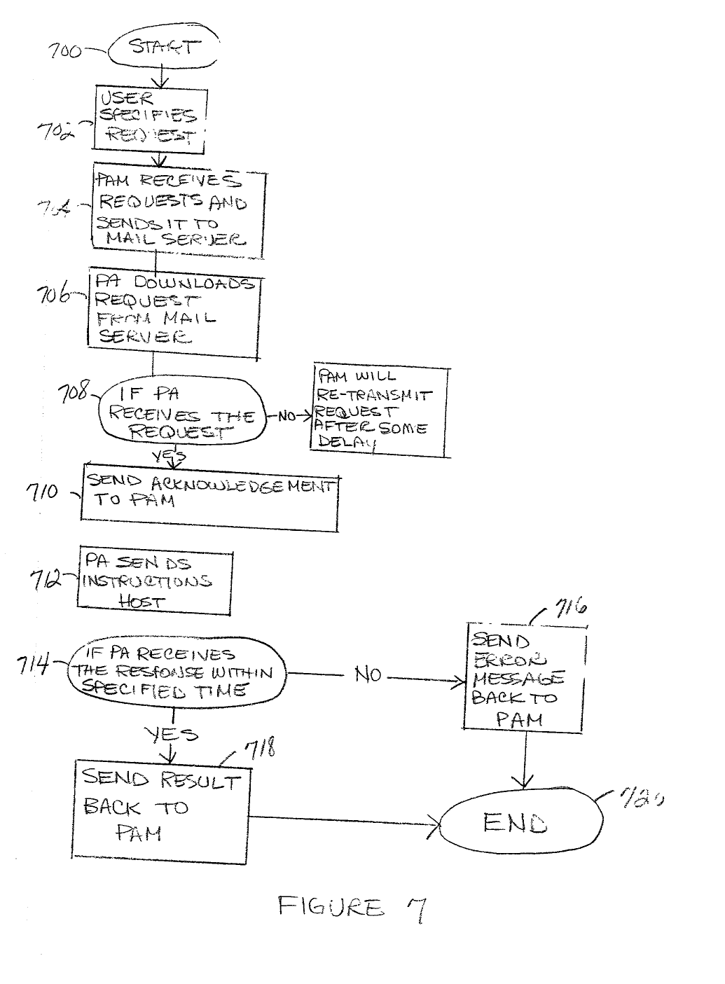

FIG. 7 is a flow chart illustrating how a request is sent to the proxy agent manager and fulfilled by a proxy agent and a result is sent back to the proxy agent manager. The process starts at 700. In a step 702, a user specifies a request using whatever interface to the proxy agent manager that is provided to the user. In one embodiment, a portal website is used by the user to interface with the proxy agent manager. In step 704, the proxy agent manager receives the request, encrypts the request and packages it in an e-mail that is sent to the mail server. In step 706, a proxy agent downloads the request from the mail server. If the proxy agent receives a request successfully, control is transferred from step 708 to step 710. If the proxy agent never successfully receives the request, then control is transferred to step 709 and the proxy agent manager retransmits the request after some delay during which the proxy agent manager does not receive an acknowledgement from the proxy agent that the request was received.

In step 710, the proxy agent sends the acknowledgement to the proxy agent manager. In step 712, the proxy agent, after processing the request into instructions that are understandable to its host, sends those instructions to the host. If the proxy agent receives the response from the host within a specified period of time, control is transferred to step 718 and the result is sent back to the proxy agent manager. If the proxy agent does not receive a response within a specified time, then control is transferred to step 716 and an error message is sent back to the proxy agent manager. Control is transferred from step 718 or 716 to step 720 and the process ends.

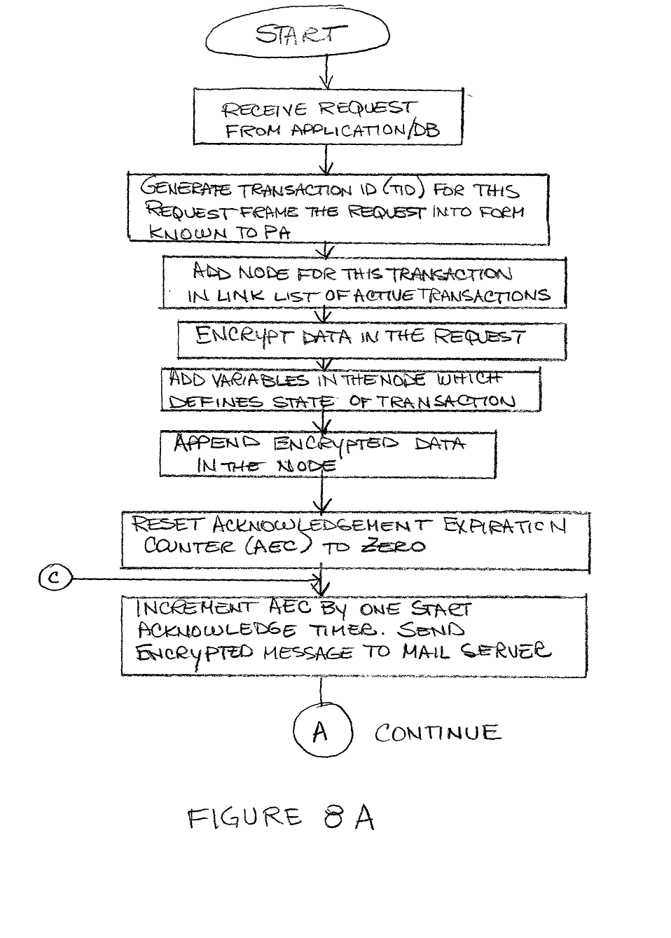

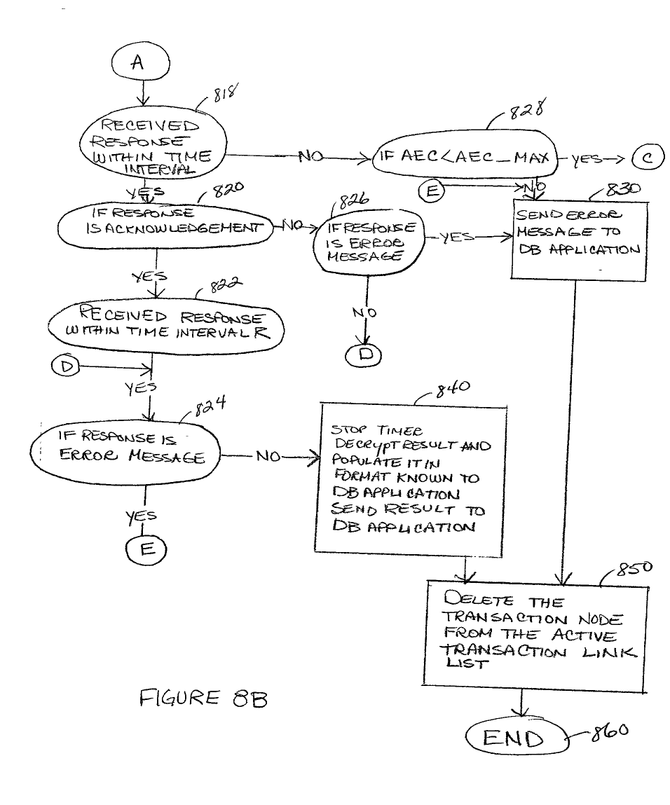

FIGS. 8A and 8B are flow charts illustrating the process executed on the proxy agent manager. The process starts at 800. In step 802, the proxy agent manager receives a request from an application or database. In step 804, a transaction ID is generated for the request. The request is framed in a form that may be recognized by a proxy agent. In step 806, a node for this transaction is added to the link list of active transactions kept by the proxy agent manager. In step 808, the data in the request is encrypted. In step 810, variables are added in the node which defines the current state of the transaction. The encrypted data is then appended in the node in step 812.

The process continues in step 814 and an acknowledge expiration counter (AEC) is set to zero. In step 816 the AEC is incremented by one and a timer is started to increment the AEC when the encrypted messages are sent to the mail server. If a response is received within a specified time interval, then control is transferred from step 818 to step 820 where it is determined whether the response is an acknowledgement. If the response is an acknowledgement, then control is transferred to step 822 and it is determined whether the response was received within a second specified time interval. If the response was received within the time interval, then control is transferred to step 824 where it is determined whether the response is an error message. If the response is an error message, then control is transferred to step 830 and an error message is sent to the database application. If the response is not an error message, then control is transferred to step 840. The timer is stopped and the result is decrypted and populated in the format known to the database application and the result is sent to the database application. Control is then transferred to 850 and the transaction node is deleted from the active transaction link list. The process then ends at 860. If a response is not received within the time interval specified in step 818, then control is transferred to step 828 where it is determined whether the acknowledgement expiration counter has expired. If it has, then control is transferred to step 816 and the message is resent. If the AEC has not expired, then control is transferred to step 830 and an error message is sent to the database application.

Thus, the proxy agent manager interfaces with the database application to generate requests, send those requests to a proxy agent, check whether the proxy agent acknowledges the request in a timely manner and, if necessary, resend the request.

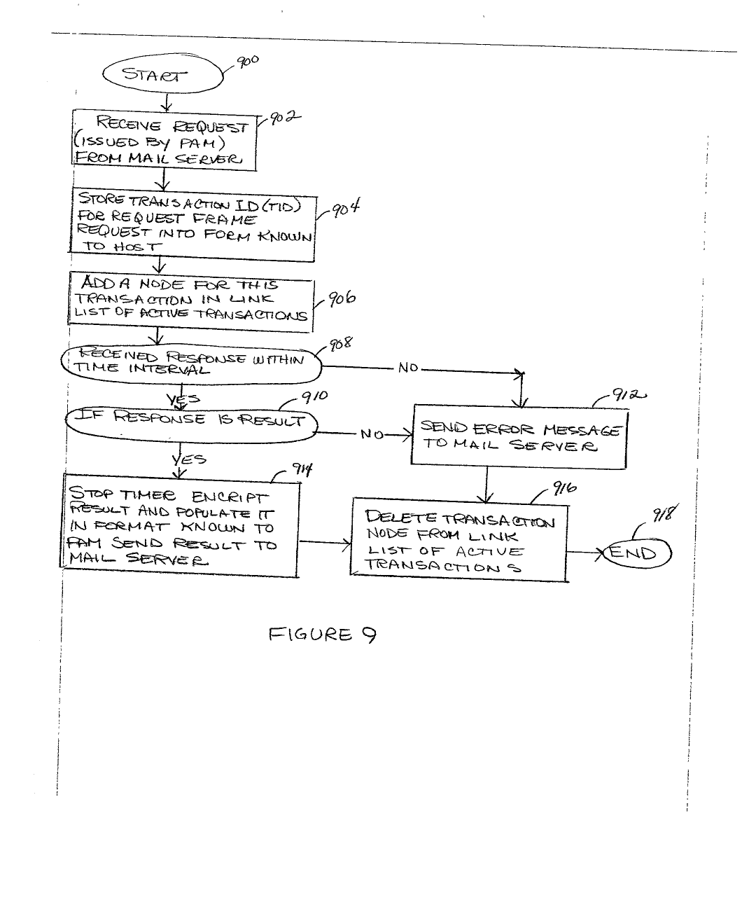

FIG. 9 is a flowchart illustrating the process implemented on a proxy agent. The process starts at 900. In a step 902, a request is received from the mail server by the proxy agent manager. In a step 904, the transaction ID is included with the request is stored and the request is framed in a form which is known to the host that the proxy agent is associated with. In one embodiment where the host is part of a network management system, the request is framed in the language used by the network management system such as SNMP. In step 906, a node is added for the transaction in the link list of active transactions maintained by the proxy agent. If a response is received within a specified time interval, then control is transferred 910 and it is determined whether the response is a result. If the response is a result, control is transferred to step 914 and the timer is stopped. The result is encrypted and populated in a format that may be read by the proxy agent manager and the result is sent to the mail server. In step 916, the transaction node is deleted from the link list of active transactions maintained by the proxy agent. The process ends at 918. If, in step 910, the response is not a result, then control is transferred to step 912 and an error message is sent to the mail server.

Thus, the proxy agent receives requests, converts them to a form readable by the host, passes the requests to the host and waits to receive response from the host within a specified time interval. If an appropriate response is received, that response is forwarded to the mail server and eventually the proxy agent manager.

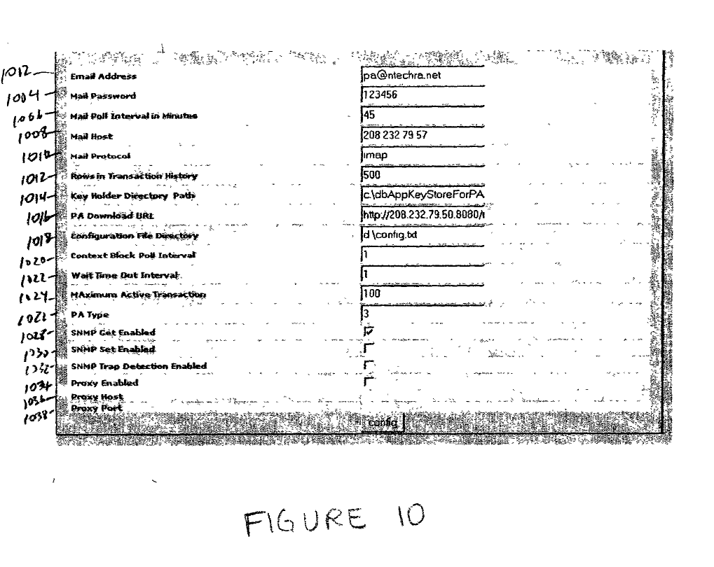

FIG. 10 is a sample screen illustrating how a proxy agent may be configured using a browser interface. An e-mail address 1002 is specified for the proxy agent. A mail password 1004 and a mail poll interval 1006 are specified so that the proxy agent may check its mail at a certain interval. A mail host 1008 is specified. The mail host may be the mail host associated with the proxy agent manager where the proxy agent manager posts mail for the proxy agent. A mail protocol 1010 is specified. The number of rows of transaction history to keep 1012 is specified. A public key directory path 1014 is specified for the purpose of encrypting messages. A download URL 1016 is specified so that the proxy agent can download software required to perform its function. A configuration file directory 1018 is specified. A context block poll interval 1020 is specified as a wait time for checking on the return of request results. A wait time out interval 1022 is specified as the frequency that the proxy agent is to check transaction states. A maximum number of active transactions 1024 is specified. A proxy agent type 1026 may be specified which indicates what kind of proxy agent is to be implemented. In one embodiment, the proxy agent may be stand alone or may be enabled with a network management system so that it may act as a channel for auto discovery. Flags 1028, 1030 and 1032 indicate whether the proxy agent is SNMP get enabled, SNMP set enabled, and whether SNMP trap detection is enabled. In this manner, the user may limit or extend the functionality of the proxy agent. Flag 1034 enables information about the proxy to be edited. The proxy host is specified in 1036 and the proxy port is specified in 1038. Thus, the proxy agent may be configured by specifying various values remotely over the internet using a web browser.

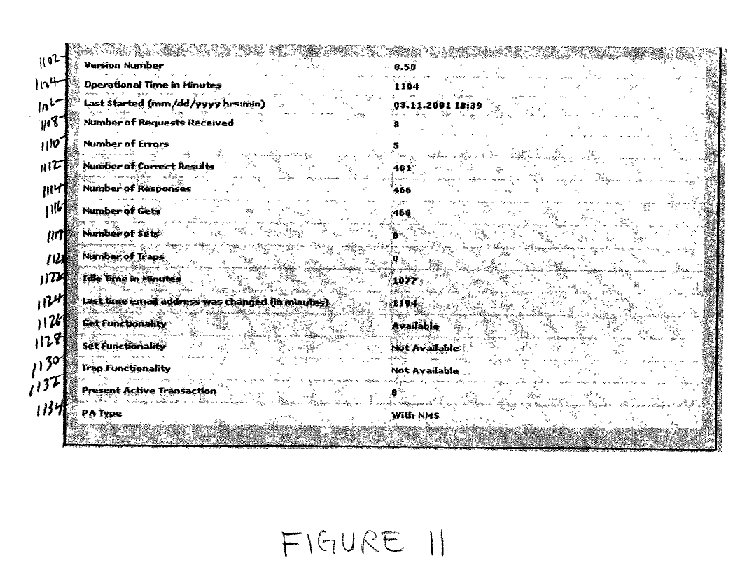

FIG. 11 is a diagram illustrating a screen that may be used by a browser to monitor the status of a proxy agent. A version 1102 keeps track of the version of software on the proxy agent. The operation time 1104 records how long the proxy agent has been operating since the last start up. The date and time of the last proxy agent start up is shown at 1106. The number of requests received is shown at 1108. A number of errors 1110 is shown as well as a number of correct results 1112. A total number of responses 1114 is shown as well as the number of gets, sets and traps 1116, 1118, and 1120. The total idle time in minutes is shown in 1122. The last time that the e-mail address of the proxy agent was changed 1124 is shown. Indicators 1126, 1128, and 1130 display whether get functionality, set functionality or trap functionality are available. Indicator 1132 shows how many active transactions are currently present; and indicator 1134 shows the proxy agent type.

A method of sending requests to a remote proxy agent using e-mail and receiving responses to the requests using e-mail has been described. In particular, the system described has been applied to remote network management where the proxy agent resides on the network and uses SNMP commands to perform network management functions. Thus, a network may be managed remotely using a proxy agent without requiring modification of the network firewall. Commands sent to the proxy agent are encrypted for security and signed for authentication so that the system may not be used by a hostile party to send commands to the proxy agent.

Other applications of the proxy agent manager and remote proxy architecture are numerous, with some examples given here below. In general, the technology can be used for any application that involves remotely executing resident programs and collecting remote information from network elements or network management systems.

In one embodiment, the proxy agent interfaces with Network Management Systems on remote sites and remotely collects information from network elements based on commands issued by the proxy agent manager.

In one embodiment, an SNMP proxy agent is used to remotely collect information directly from the network elements and to configure them.

In one embodiment, the proxy agent manager to proxy agent communication protocol is used to communicate with existing (i.e., already installed) test programs, or to download test programs to a remote host. The protocol is then used to execute commands remotely, such as a command to run a particular test program, and to collect results and send the results back to the proxy agent manager for parsing.

In one embodiment, a semiconductor manufacturer tests integrated circuit devices (chips) using remote test stations. The test stations contain printed circuit board modules, for which the proxy agent can be used to access and perform diagnostics via SNMP (Simple Network Management Protocol) of the MIB (Management Information Bytes). In one embodiment, such testing can be performed by anyone, anywhere, anytime via a web browser. The MIB information collected is then used to populate a trouble ticketing system for use by the semiconductor manufacturer in delivering service to their customers.

In one embodiment, a smart trouble ticket service is provided. Business and technical related data are compiled, which data is automatically collected via a central repository and real-time collection of MIB data via SNMP for an identified hardware device. This data is compiled prior to submitting the trouble ticket to the manufacturer for resolution. Additionally, the real-time MIB information is processed by a knowledge base configured to perform trend analysis of MIB1 and/or MIB2 variables.

In one embodiment, test scripts and test programs can be downloaded to end customers via a secure proxy agent manager to perform specific routines that exercise the manufacturer's hardware in order to determine the health of the hardware/software. Management Information Bytes (MIB), are then collected via SNMP and populated in a central repository/database for use in trouble ticketing and network product and trend analysis.

In one embodiment, a knowledge base uses a fuzzy logic type data program to provide Internet infrastructure manufacturers, their business partners and end customers with an intelligent trend analysis for selective and associative MIB data. The analysis is then displayed in both table and graphical formats with probable causes of the suspected problem in order of probability of most likely towards least likely.

In one embodiment, end customers use network tools to trouble shoot their hardware before automatically contacting their hardware manufacturer. Network tools may be a simple ping of the device (asset) to a complete collection and trend analysis of MIB data. Furthermore, the MIB data collection can be done multiple times with each being time and date stamped.

Also provided as part of network tools is the capability to search the manufacturer's knowledge base and their software bug database. If a trouble ticket is opened, information as a result of running each tool will be appended to the trouble ticket separately so that the information is distinct from the results of running other network tools. These results can be opened as “windows” of the web browser.

In one embodiment, each optical wavelength in an inventory is treated as an asset in an asset management database. Furthermore, detailed information about each wavelength in addition to that which can be provided by its MIB, such as the wavelength's physical origination, destination and passive optic connections are provided for in an associated additional asset detail database table.

In one embodiment, Internet infrastructure manufacturers are provided with the ability to interrogate the selected MIB variables of their end customers' equipment and behind the end customers' firewall if one is present. The audit is made up of MIB variables selected by the manufacturer's personnel (e.g., salespeople). The data collection of the selected MIB variables can be performed on command or at a future time and date scheduled by the manufacturer. The information provided via the net audit provides the manufacturer with the utilization factor of the installed hardware at its end customer's locations and with detailed asset information, i.e., location, modules used in chassis, hardware and software version numbers, and more.

In one embodiment, graphical dashboards, which are updated with specific product information real-time, are provided. For example, product quantities displayed on the dashboard are updated real-time for each occurrence of an addition or deletion of an asset. Also, the number of trouble tickets associated with a specific product is displayed graphically and the graph is updated real-time with the opening or closing of a trouble ticket. In one embodiment, the graphical dashboard is displayed via a web page accessible via the Internet.

In one embodiment, action items on a to-do type list are automatically created and tracked as a result of a predefined trigger event. For example, if a manufacturer expects that a like piece of hardware will be returned, an entry in the “to-do” list is automatically created, which informs the manufacturer's agent to expect the returned hardware by a predefined date.

With only one piece of unique identification, i.e., serial number, IP address, etc., collecting the asset's MIB 1 or MIB 2 variables is performed automatically in one embodiment. The proxy agent manager interfaces to both the asset management database as well as the end customer's proxy agent, which typically is behind the customer's firewall. The wire line transmission between PA-PAM is fully encrypted. The proxy agent interfaces to either the end customer's Network Management System (NMS) or communicates directly with the identified asset. After data collection of the MIB via SNMP, the asset's information is transmitted via encrypted wire line to the proxy agent manager which interfaces to an asset management database.

In one embodiment, a maintenance contract database provides for the automatic renewal of maintenance contracts, which are about to expire in “X” number of days. “X” is the number of days determined by the Internet infrastructure manufacturer. The system will automatically notify the manufacturer's end customer via email and/or the web that a specific maintenance contract will expire. The system gives the end customer the ability to renew the same contract with the click of a button on the web browser or via a positive response to the email notification.

In one embodiment, the asset management database, automated MIB data collection, and knowledge base analysis described herein are used as the primary focus to customer relationship management.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. A method of sending network device instructions to a network device comprising:
receiving an application instruction generated by an application;
uploading proxy agent instructions derived from the application instructions to a mail server; and
confirming that the proxy agent instructions have been downloaded by a proxy agent.

2. A method of sending network device instructions to a network device as recited in claim 1 wherein the proxy agent instructions are substantially the same as the application instructions.

3. A method of sending network device instructions to a network device as recited in claim 1 further including encrypting the proxy agent instructions.

4. A method of sending network device instructions to a network device as recited in claim 1 further including authenticating the proxy agent instructions.

5. A method of sending network device instructions to a network device as recited in claim 1 further including determining the proxy agent that is associated with the network device.

6. A method of sending network device instructions to a network device as recited in claim 1 further including specifying the address of the proxy agent that is to execute the proxy agent instructions.

7. A method of sending network device instructions to a network device as recited in claim 1 wherein confirming that the instructions have been downloaded by a proxy agent includes receiving an acknowledgment from the proxy agent that the instructions have been received.

8. A method of sending network device instructions to a network device as recited in claim 1 wherein the mail server sends the proxy agent instructions to a proxy agent mail server from which the proxy agent may download the instructions.

9. A method of sending network device instructions to a network device as recited in claim 1 wherein the proxy agent downloads the instructions directly from the mail server.

10. A method of sending network device instructions to a network device as recited in claim 1 wherein the proxy agent instructions are associated with a session identifier.

11. A method of sending network device instructions to a network device as recited in claim 1 wherein the proxy agent instructions are associated with a session identifier and wherein the session identifier is used to identify the proxy agent instructions downloaded by the proxy agent.

12. A method of sending network device instructions to a network device as recited in claim 1 wherein the network device is behind a firewall.

13. A method of receiving network device instructions for a network device comprising:
downloading a message from a mail server, the message including the network device instructions;
authenticating the message; and
parsing the instructions.

14. A method of receiving network device instructions as recited in claim 13 wherein the network device instructions are derived from instructions generated by an application.

15. A method of receiving network device instructions as recited in claim 13 further including sending an acknowledgment that the instructions have been received.

16. A method of receiving network device instructions as recited in claim 13 further including executing the instructions and uploading results to the mail server.

17. A method of receiving network device instructions as recited in claim 13 further including managing a network according to the network device instructions.

18. A method of sending network device instructions to a network device as recited in claim 1 further including gathering network data according to the network device instructions and reporting the results.

19. A proxy agent manager for sending network device instructions to a network device comprising:
an application interface configured to receive an application instruction generated by an application; and
a mail server interface configured to upload proxy agent instructions derived from the application instructions to a mail server and configured to confirm that the proxy agent instructions have been downloaded by a proxy agent.

20. A network device for executing instructions from a remote manager comprising:
a mail server interface configured to download a message from a mail server, the message including the instructions;
a processor configured to authenticate the message and to parse the instructions.
